(19) United States
(12) Patent Application Publication
(10) Pub. No.: US 2025/0314954 A1
(43) Pub. Date: Oct. 9, 2025

(54) LIGHT SOURCE DEVICE, IMAGE PROJECTION APPARATUS, AND METHOD FOR ADJUSTING LIGHT SOURCE DEVICE

(71) Applicants: Kazuhiro FUJITA, Tokyo (JP); Kasumi NAKAMURA, Kanagawa (JP); Osamu SATO, Kanagawa (JP)

(72) Inventors: Kazuhiro FUJITA, Tokyo (JP); Kasumi NAKAMURA, Kanagawa (JP); Osamu SATO, Kanagawa (JP)

(21) Appl. No.: 19/096,738

(22) Filed: Apr. 1, 2025

(30) Foreign Application Priority Data
Apr. 5, 2024 (JP) 2024-061716

(51) Int. Cl. G03B 21/20

(52) U.S. Cl. CPC G03B 21/204

(57) ABSTRACT

A light source device includes a first light source module including a first light source to emit a first light-source light, a first phosphor wheel reflects the first light source light and generates second light source light, a second light source module including a second light source to emit a third light-source light, a second phosphor wheel reflects the third light source light and generates fourth light source light, a color wheel including a color spoke, and a control unit to controls the first light source module and the second light source module to form first color-side spots on the color wheel and controls the color wheel to cause the color spoke to passes through from the first color-side spot to the second color-side spot or from the second color-side spot to the first color-side spot.

### CROSS-REFERENCE TO RELATED APPLICATIONS

This patent application is based on and claims priority pursuant to 35 U.S.C. § 119(a) to Japanese Patent Application No. 2024-061716, filed on Apr. 5, 2024, in the Japan Patent Office, the entire disclosure of which is hereby incorporated by reference herein.

### BACKGROUND

### Technical Field

The present disclosure relates to a light source device, an image projection device, and a method for adjusting the light source device.

### Related Art

In the related art, some illumination techniques are known that a disc-shaped color wheel including multiple filters, for example, multiple dichroic filters disposed in a circumferential region of a rotating body is rotated to sequentially switch the filters to obtain light having each color of the filters, and the light having each color is used as illumination light. When a color wheel is used, in a time period (i.e., spoke time) in which a boundary (i.e., spoke) between filters passes through a spot of light source light, filters having different characteristics of light transmittance pass through the spot of the light source light. As a result, color mixing occurs within the time period. Since this spoke time cannot be eliminated, it is necessary to shorten the time for color mixing.

Some techniques using such a color wheel have been proposed in the related art. In some techniques, two light source units each including a phosphor wheel (i.e., wavelength conversion wheel) including a wavelength conversion region and a reflection region are used to time-sequentially generate a color (e.g., blue) of the light source light having a wavelength and another color (e.g. yellow) of another light having another wavelength different from the wavelength of the light source light by time-sequentially irradiating the wavelength conversion region and the reflection region with the light source light.

### SUMMARY

According to an embodiment of the present disclosure, a light source device includes a first light source module including: a first light source to emit a first light-source light having a first wavelength; a first phosphor wheel including a first disc rotating about a central axis of the first disc, a second light source module including: a second light source to emit a third light-source light having a third wavelength; a second phosphor wheel including a second disc rotating about a central axis of the second disc, a color wheel having a third disc rotating about a central axis of the third disc, and circuitry The first phosphor wheel includes multiple regions having a first region to reflect the first light-source light emitted from the first light source, and a second region to generate a second light-source light having a second wavelength different from the first wavelength of the first light-source light from the first light-source light, to form a first phosphor-side spot on the first phosphor wheel by the first light-source light or the second light-source light. The second phosphor wheel includes multiple regions having a third region to reflect the third light-source light emitted from the second light source and a fourth region to generate a fourth light-source light having a fourth wavelength different from the third wavelength of the second light-source light from the third light-source light, to form a second phosphor-side spot on the second phosphor wheel by the third light-source light or the fourth light-source light. The color wheel includes multiple filter regions having transmittances different from each other and a color spoke between the multiple filter regions. The circuitry controls the first light source module to form a first color-side spot on the color wheel by one of the first light-source light or the second light-source light, controls the second light source module to form a second color-side spot on the color wheel by one of the third light-source light or the fourth light-source light, controls the color wheel to cause the color spoke to passes through from the first color-side spot to the second color-side spot or from the second color-side spot to the first color-side spot.

According to an embodiment of the present disclosure, an image projection apparatus includes the light source device, and a light tunnel having an entrance surface having a rectangular shape having a longitudinal side and a lateral side, to uniformize light source light passed through the color wheel. The first light source module and the second light source module form light-condensed spots at the entrance surface of the light tunnel. The light-condensed spots are aligned in a direction of the longitudinal side of the entrance surface.

According to an embodiment of the present disclosure, a method for adjusting a light source device includes adjusting a timing of a first phosphor wheel to pass a first phosphor spoke of the first phosphor wheel through a first phosphor-side spot of the first phosphor wheel when a color spoke of a color wheel passes through a first color-side spot of the color wheel, and adjusting a timing of a second phosphor wheel to pass a second phosphor spoke of the second phosphor wheel through the first phosphor-side spot when the color spoke of the color wheel passes through a second color-side spot of the color wheel.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a basic configuration of a light source device;

FIG. 2A is a diagram illustrating a configuration of a phosphor wheel of a light source device;

FIG. 2B is a diagram illustrating a configuration of a color wheel of a light source device;

FIG. 3 is a diagram illustrating an image projection apparatus;

FIG. 4 is a diagram illustrating an optical path of fluorescent light in an image projection apparatus;

FIG. 5 is a diagram illustrating a spot of light source light going in an entrance surface of a light tunnel of a light source device;

FIG. 6 is a diagram illustrating a hardware configuration of an image projection apparatus;

FIGS. 7A and 7B are diagrams illustrating a timing of a spoke time of a phosphor wheel in a light source device;

FIG. 7C is a diagram illustrating a timing of a spoke time of a color wheel in the light source device;

FIG. 8A is a diagram illustrating positional relations between a spoke of a phosphor wheel, another spoke of another phosphor wheel, and a spot of light source light in a light source device at a time T1;

FIG. 8B is a graph of output of the light source light passed through the color wheel at the time T1;

FIG. 9A is a diagram illustrating positional relations between a spoke of a phosphor wheel, another spoke of another phosphor wheel, and a spot of light source light in a light source device at a time T2;

FIG. 9B is a graph of output of the light source light passed through the color wheel at the time T2;

FIG. 10A is a diagram illustrating positional relations between a spoke of a phosphor wheel, another spoke of another phosphor wheel, and a spot of light source light in a light source device at a time T3;

FIG. 10B is a graph of output of the light source light passed through the color wheel at the time T3;

FIG. 11A is a diagram illustrating positional relations between a spoke of a phosphor wheel, another spoke of another phosphor wheel, and a spot of light source light in a light source device at a time T4;

FIG. 11B is a graph of output of the light source light passed through the color wheel at the time T4;

FIG. 12A is a diagram illustrating positional relations between a spoke of a phosphor wheel, another spoke of another phosphor wheel, and a spot of light source light in a light source device at a time T5;

FIG. 12B is a graph of output of the light source light passed through the color wheel at the time T5;

FIG. 13A is a diagram illustrating positional relations between a spoke of a phosphor wheel, another spoke of another phosphor wheel, and a spot of light source light in a light source device in a case where a timing when the spoke passes through the spot and another timing when the other spoke passes through the spot are matched;

FIG. 13B is a graph of output of the light source light passed through the color wheel in a case where a timing when the spoke passes through the spot and another timing when the other spoke passes through the spot are matched; and

FIG. 14 is a diagram illustrating a transit time that a spoke of a color wheel passes through a space between two spots in in the light source device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present disclosure, a light use efficiency in the spoke time can be increased.

Embodiments of a light source device, an image projection apparatus, and a method for adjusting the light source device according to the present disclosure will be described in detail below with reference to the drawings. The present disclosure is not limited to the following embodiments, and the constituent elements of the embodiments includes those which can be easily conceived by those skilled in the art, substantially the same ones, and those in the following embodiments include those which can be easily conceived by those skilled in the art, substantially the same, and within equivalent ranges. Further, various omissions, substitutions, changes and combinations of constituent elements can be made without departing from the gist of the following embodiments.

### Basic Configuration of Light Source Device

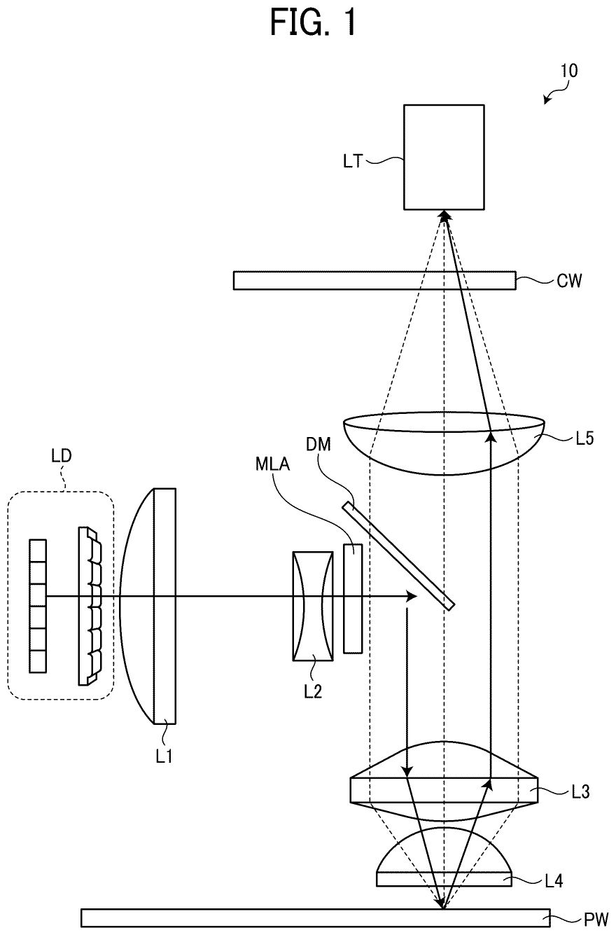

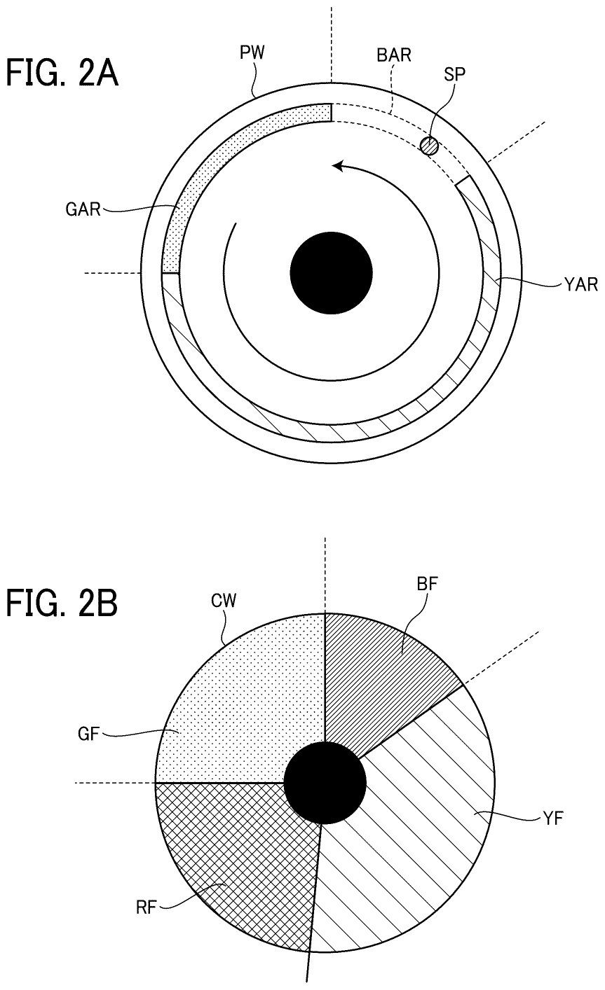

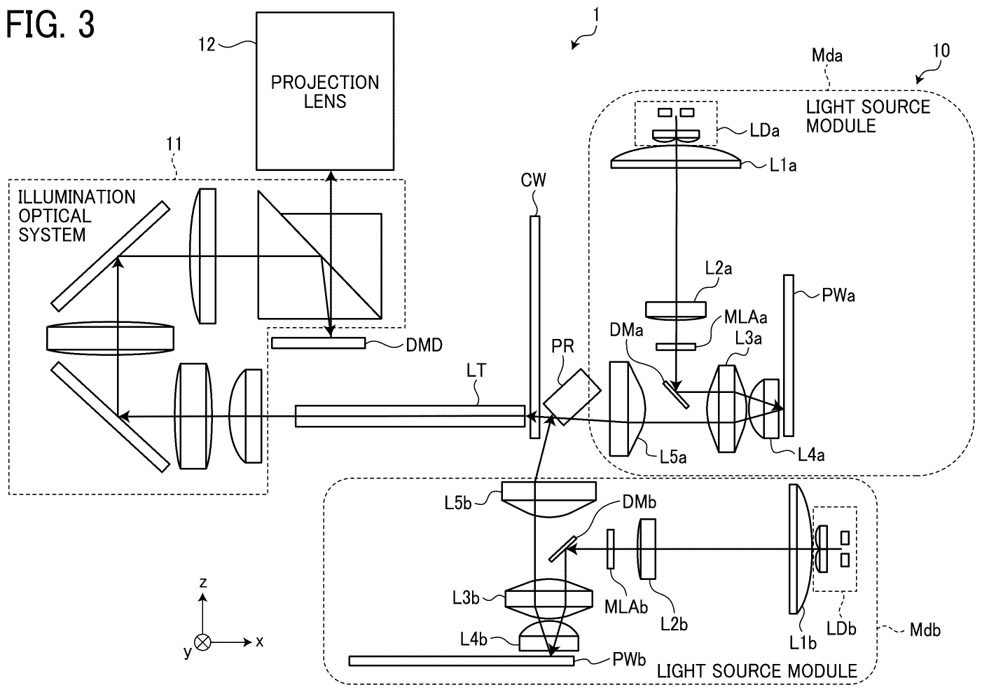

FIG. 1 is a diagram illustrating a basic configuration of a light source device. FIG. 2A is a diagram illustrating a configuration of a phosphor wheel of a light source device, and FIG. 2B is a diagram illustrating a configuration of a color wheel of a light source device. The basic configuration of the light source device 10 will be described with reference to FIGS. 1, 2A, and 2B In FIG. 1, a configuration of a basic unit in which light source light emitted from one light source LD goes in a light tunnel LT is described, and a configuration of a light source device 10 including the two basic units will be described later with reference to FIG. 3.

In FIG. 1, the light source device 10 includes a light source LD, lenses L1 and L2, a microlens array MLA, a dichroic mirror DM, lenses L3 and L4, a phosphor wheel PW, a lens L5, a color wheel CW, and a light tunnel LT.

The light source LD is a laser array light source in which light sources that emit, for example, blue excitation light are arrayed. The light source LD is preferably, for example, a semiconductor laser light source in order to emit blue excitation light. The light source LD is preferably, for example, a blue laser light source in which the excitation light has a peak between 440 to 465 nanometers (nm). In order to increase the irradiation power, the light source LD uses multiple laser diodes (LDs) and emits light with a power of several tens to one hundred watt (W) or greater. The light source LD includes a collimator lens array that condenses light emitted from each LD so as to be substantially parallel light. In the collimator lens array, multiple collimator lenses are arrayed, and the number of collimator lenses correspond to the number of LDs in the LD array (e.g., 7×2 or 7×4). In the following description, the light that originates from the light source LD and is transmitted, reflected, or diffused in the following optical systems may be collectively referred to as “light source light.”

The lenses L1 and L2 are the optical system members that converge the light source light, which is the parallel light emitted from the light source LD, converts the light into a thin light flux, and guides the thin light flux to the dichroic mirror DM.

The microlens array MLA is an optical system member that divides the light source light transmitted through the lenses L1 and L2 into multiple beams and superimposes a portion or all of the divided beams. Accordingly, the irradiation density of the light source light that goes in the phosphor wheel PW disposed in the following optical path of the light source light can be uniformized. In FIG. 1, the microlens array MLA is disposed behind the lens L2. However, the configuration is not limited to this, and, for example, the microlens array MLA may be disposed between the lens L1 and the lens L2.

The dichroic mirror DM is an optical system member that bends the optical path by reflecting the light source light (i.e., blue light) emitted from the microlens array MLA and guides the light to the lens L3.

The lenses L3 and L4 are optical system members that condense the light source light reflected by the dichroic mirror DM and guide the light source light to the phosphor wheel PW.

The phosphor wheel PW is a disc-shaped optical system member that reflects light source light (i.e., blue light) emitted from the lens L4 or converts the light source light into light having another color by wavelength conversion. As illustrated in FIG. 2A, the phosphor wheel PW includes a reflection region BAR in which the region that reflects light source light (i.e., blue light) emitted from the lens L4 is formed, a wavelength conversion region YAR in which a phosphor that converts the wavelength of the light source light into yellow light is formed, and a wavelength conversion region GAR in which a phosphor that converts the wavelength of the light source light into green light is formed. The reflection region BAR, the wavelength conversion region YAR, and the wavelength conversion region GAR are formed so as to be divided into an annular shape. As illustrated in FIG. 2A, the spot SP, which is a spot portion at which the light source light converged by the lens L4 strikes the phosphor wheel PW, may be referred to as a “phosphor-side spot”. In addition, the boundary between the adjacent regions among the reflection region BAR, the wavelength conversion region YAR, and the wavelength conversion region GAR may be referred to as “phosphor spoke” in the following description. The reflection region BAR, the wavelength conversion region GAR, and the wavelength conversion region YAR are examples of “multiple regions” of the present disclosure.

The phosphor wheel PW is rotated by a phosphor wheel drive circuit 812 described later via a motor, and is controlled such that the position of a phosphor-side spot formed by the light source light emitted from the lens L4 is time-sequentially switched to the reflection region BAR, the wavelength conversion region YAR, and the wavelength conversion region GAR. For example, when the phosphor-side spot is located in the reflection region BAR, the reflection region BAR reflects the light source light and causes the light source light that is blue light to go in the lens L4. When the phosphor-side spot is located in the wavelength conversion region YAR, the wavelength conversion region YAR converts the wavelength of the light source light into a wavelength of yellow fluorescent light and causes the fluorescent light to go in the light source lighting target region L4. When the phosphor-side spot is located in the wavelength conversion region GAR, the wavelength conversion region GAR converts the wavelength of the light source light into a wavelength of green fluorescent light and causes the fluorescent light to go in the light source lighting target region L4.

The fluorescence light wavelength-converted in the wavelength conversion regions YAR or GAR is converted into substantially parallel light by the lenses L4 and L3. A portion of the fluorescence light directly goes in the lens L5, and another potion of the fluorescence light goes in the lens L5 after passing through the dichroic mirror DM. The reflection region BAR is irradiated with the blue light source light. The blue light source light is reflected at the reflection region BAR and turned back, and then transmitted through the lenses L4 and L3, passes through near the dichroic mirror DM, and goes in the lens L5.

The lens L5 is an optical system member that collects the light source light reflected by the phosphor wheel PW or wavelength-converted light source light and guides the collected light source light to the color wheel CW.

The color wheel CW is a disc-shaped optical system member to cause the light source light of each color to time-sequentially go in the light tunnel LT by passing the light source light emitted from the lens L5 through the filter region of each color. As illustrated in FIG. 2B, the color wheel CW includes a filter region BF that transmits the blue light source light reflected from the reflection region BAR of the phosphor wheel PW and emitted from the lens L5, a filter region YF that transmits the yellow light source light (i.e., fluorescent light) wavelength-converted by the wavelength conversion region YAR of the phosphor wheel PW and emitted from the lens L5, a filter region RF that transmits the red light included in the yellow light source light (i.e., fluorescent light), and a filter region GF that transmits green light source light (i.e., fluorescent light) wavelength-converted by the wavelength conversion region GAR of the phosphor wheel PW and emitted from the lens L5. The filter region BF, the filter region YF, the filter region RF, and the filter region GE are formed so as to be divided into an annular shape. A portion of the color wheel CW that the light source light condensed by the lens L5 strikes in a spot shape may be referred to as a “color-side spot”. In addition, the boundaries between the adjacent regions among the filter region BF, the filter region YF, the filter region RF, and the filter region GF may be referred to as color spoke” in the following description.

The color wheel CW is rotated by a color wheel drive circuit 813 described later via a motor, and is controlled such that the position of a color-side spot formed by the light source light emitted from the lens L5 is time-sequentially switched to the filter region BF, the filter region YF, the filter region RF, and the filter region GF. For example, when the color-side spot is located in the filter region BF, the filter region BF transmits the blue light source light and causes the blue light source light to go in the light tunnel LT. When the color-side spot is located in the filter region YF, the filter region YF transmits the yellow light source light and causes the yellow light source light to go in the light tunnel LT. When the color side spot is located in the filter region RF, the filter region RF transmits the red light source light and causes the red light source light to go in the light tunnel LT. When the color-side spot is located in the filter region GF, the filter region GF transmits the green light source light and causes the green light source light to go in the light tunnel LT.

The light tunnel LT is an optical system member that superimposes and uniformizes the light source light of each color transmitted through the color wheel CW by repeating total internal reflection several times at an internal interface. The light tunnel LT has an entrance surface having an aspect ratio substantially equal to the aspect ratio of a digital micromirror device used in an image projection apparatus 1, which is described later, including the light source device 10.

In the light source device 10 illustrated in FIG. 1, the timing at which the phosphor spokes of the phosphor wheel PW pass through the phosphor-side spot is matched with the timing at which the color spokes of the color wheel CW pass through the color-side spot. Accordingly, the time of color mixing can be minimized. However, when there are multiple configurations of the basic unit in which the light source light emitted from one light source LD goes in the light tunnel LT as illustrated in FIG. 1, multiple color-side spots corresponding to the configurations are formed on the color wheel CW. In the case where any layout of the light source device 10 can be designed, a configuration in the related art can be used as it is if the multiple color-side spots are disposed such that the color spoke passes through the multiple color-side spots at the same time. However, in the case where there is a restriction on the size reduction of the image projection apparatus 1 or the layout of the light source device 10, it may be preferable that the multiple color-side spots are not disposed such that the color spoke passes through the multiple color-side spots at the same time, or it may be more prioritized that the rotation center of the color wheel CW is arranged at any position. According to the present embodiment, the light source device 10 having high light use efficiency can be provided even in such a case.

### Configuration of Image Projection Apparatus

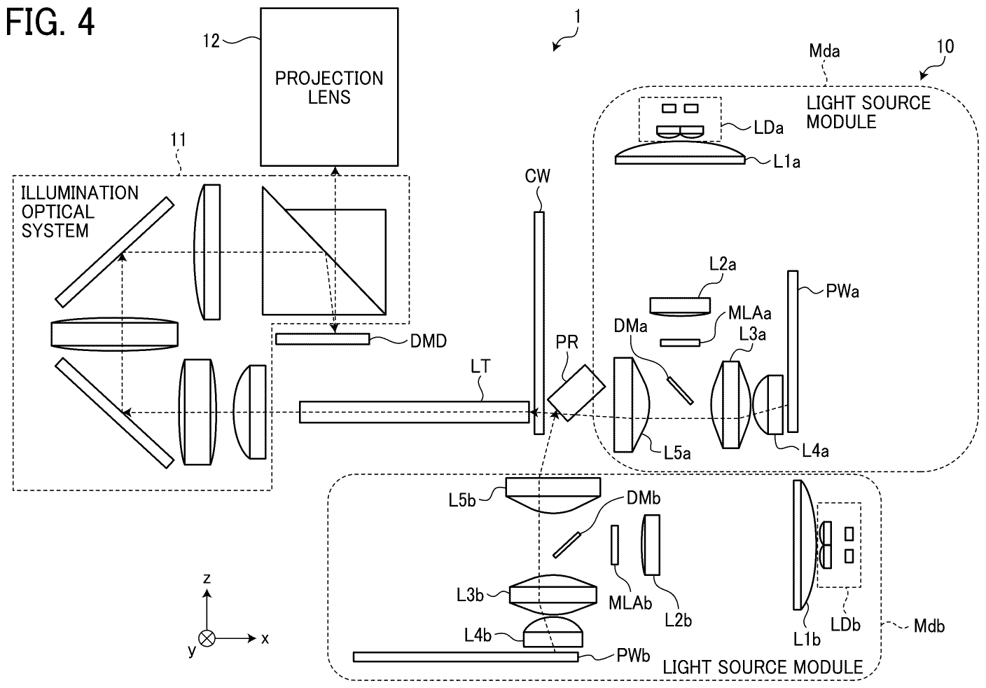

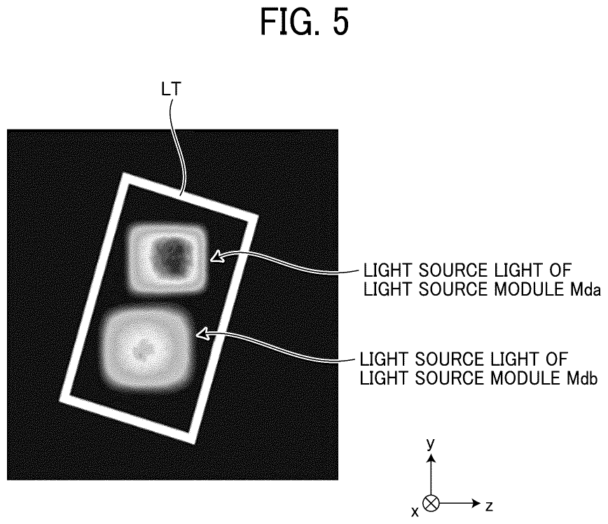

FIG. 3 is a diagram illustrating an image projection apparatus. FIG. 4 is a diagram illustrating an optical path of fluorescent light in an image projection apparatus. FIG. 5 is a diagram illustrating a spot of light source light going in an entrance surface of a light tunnel of a light source device. The configuration of the light source device 10 having two basic unit configurations in which the light source light irradiated from the light source LD goes in the light tunnel LT, and the configuration of the image projection apparatus 1 including the light source device 10 will be described with reference to FIGS. 3 to 5.

As illustrated in FIG. 3, the image projection apparatus 1 includes a light source device 10, an illumination optical system 11, a digital micromirror device DMD, and a projection lens 12 (i.e., projection optical system). As illustrated in FIG. 3, the light source device 10 includes a light source module Mda (an example of a first light source module), a light source module Mdb (an example of a second light source module), a prism PR, a color wheel CW, and a light tunnel LT. The light source modules Mda and Mdb correspond to the above-described basic units.

As illustrated in FIG. 3, the light source module Mda includes a light source LDa (an example of a first light source), lenses L1a and L2a, a microlens array MLAa, a dichroic mirror DMa, lenses L3a and L4a, a phosphor wheel PWa (an example of a first phosphor wheel), and a lens L5a. As illustrated in FIG. 3, the light source module Mdb includes a light source LDb (an example of a second light source), lenses L1b and L2b, a microlens array MLAb, a dichroic mirror DMb, lenses L3b and L4b, a phosphor wheel PWb (an example of a second phosphor wheel), and a lens L5b. The functions of the light sources LDa and LDb, the lenses L1a and L1b, the lenses L2a and L2b, the microlens arrays MLAa and MLAb, the dichroic mirrors DMa and DMb, the lenses L3a and L3b, the lenses L4a and L4b, the phosphor wheels PWa and PWb, and the lenses L5a and L5b are the same as the functions of the light sources LD, the lenses L1 and L2, the microlens arrays MLA, the dichroic mirrors DM, the lenses L3 and L4, the phosphor wheels PW, and the lenses L5 illustrated in FIG. 1. The function of the color wheel CW is as described above with reference to FIG. 1.

In a case where the light sources LDa and LDb, the lenses L1a and L1b, the lenses L2a and L2b, the microlens arrays MLAa and MLAb, the dichroic mirrors DMa and DMb, the lenses L3a and L3b, the lenses L4a and L4b, the phosphor wheels PWa and PWb, and the lenses L5a and L5b are respectively indicated as any one of each pair of members or collectively referred to, these members are simply referred to as “the lens L1”, “the lens L2”, “the microlens array MLA”, “the dichroic mirror DM”, “the lens L3”, “the lens L4”, “the phosphor wheel PW”, and “the lens L5”, respectively.

The optical members included in the light source modules Mda and Mdb are disposed on a plane parallel to the ZX-plane (i.e., horizontal plane). The light source modules Mda and Mdb are disposed on a plane separated by a predetermined distance in the y-direction.

The prism PR is an optical member that reflects the light source light emitted from the light source module Mdb (i.e., the light source light emitted from the lens L5b) and causes the light source light to go in the light tunnel LT via the color wheel CW. As described above, since the light source modules Mda and Mdb are disposed on planes separated by a predetermined distance in the y-direction, the light source light emitted from the light source module Mda (i.e., the light source light emitted from the lens L5a) passes through an area in front of the prism PR as viewed from the plane on which FIG. 3 is illustrated (i.e., without passing through the prism PR) and directly goes in the light tunnel LT via the color wheel CW. In order to reflect the light source light emitted from the light source module Mdb, for example, a flat mirror may be used instead of the prism PR.

The light tunnel LT superimposes and uniformizes the light source light from the light source modules Mda and Mdb transmitted through the color wheel CW by repeating total internal reflection several times at the internal interface. The light tunnel LT is a member having a refractive index, such as a glass member, and may be a glass rod utilizing total internal reflection. The light source light emitted from the light source modules Mda and Mdb is most condensed near the entrance surface of the light tunnel LT. As illustrated in FIG. 5, the entrance surface of the light tunnel LT has a rectangular shape having a longitudinal side in the substantially y-direction and a lateral side in the substantially x-direction. The exit surface of the light tunnel LT also has a rectangular shape having a longitudinal side in the substantially y-direction and a lateral side in the substantially x-direction. Further, the light collecting points of the light source light from the light source modules Mda and Mdb that go in the entrance surface of the light tunnel LT are separated from each other as illustrated in FIG. 5. In this case, as illustrated in FIG. 5, the light tunnel LT is disposed such that the direction in which the light collecting points are arranged substantially coincides with the longitudinal side direction (i.e., substantially y-direction) of the entrance surface. Since the light source light from the light source modules Mda and Mdb also passes through the color wheel CW disposed just before the entrance surface of the light tunnel LT, two color-side spots are formed on the color wheel CW. The light tunnel LT has an entrance surface and an exit surface having an aspect ratio substantially equal to the aspect ratio of a digital micromirror device DMD. The aspect ratio of the entrance surface of the light tunnel LT and the aspect ratio of the digital micromirror device DMD may be substantially the same, and the entrance surface and the exit surface of the light tunnel LT may not have the same shape.

The illumination optical system 11 is an optical system unit that illuminates the digital micromirror device DMD with the uniformized light source light emitted from the light tunnel LT.

The digital micromirror device DMD is a two-dimensional optical modulator that converts light source light emitted from the illumination optical system 11 into image light including an image with a large number of movable micromirrors. The image light converted by the digital micromirror device DMD goes in the projection lens 12.

The projection lens 12 is an optical system member that projects the image light converted by the digital micromirror device DMD onto a screen.

FIG. 4 is a diagram illustrating the optical paths of the fluorescent light, in which the wavelength of the light source light that goes in the wavelength conversion regions of the phosphor wheels PWa and PWb is converted. The fluorescent light passes through the lenses L4a and L3a and the lenses L4b and L3b, respectively, and goes in the light tunnel LT via the color wheel CW.

### Hardware Configuration of Image Projection Apparatus

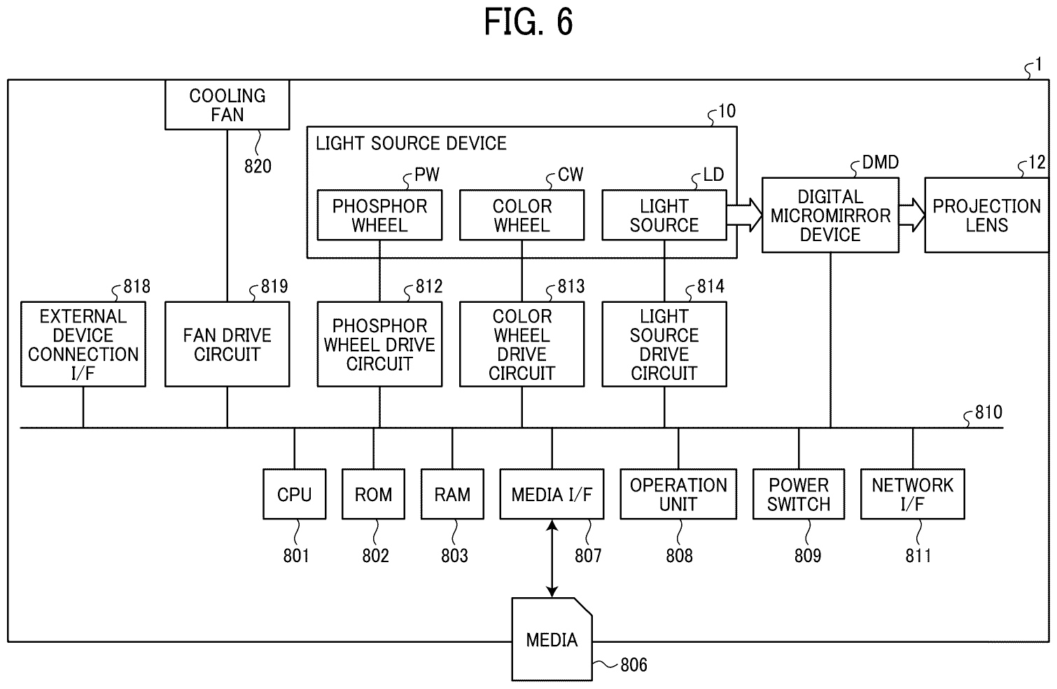

FIG. 6 is a diagram illustrating a hardware configuration of the image projection apparatus 1. Referring to FIG. 6, the hardware configuration of the image projection apparatus 1 will be described.

As illustrated in FIG. 6, the image projection apparatus 1 includes a central processing unit (CPU) 801, a read-only memory (ROM) 802, a random-access memory (RAM) 803, a media interface (I/F) 807, an operation unit 808, a power switch 809, a network I/F 811, a phosphor wheel drive circuit 812, a color wheel drive circuit 813, and a light source drive circuit 814.

The CPU 801 is a computing device that controls the operation of the entire image projection apparatus 1. The ROM 802 is a nonvolatile storage device that stores a program used for driving the CPU 801. The RAM 803 is a volatile storage device used as a work area of the CPU 801.

The media I/F 807 is an interface circuit that controls the media 806 such as a flash memory to read or write (i.e., store) data.

The operation unit 808 includes various keys, buttons, or a light-emitting diode (LEDs), and is used to perform various operations other than on and off (ON/OFF) of the power supply of the image projection apparatus 1 by the user. For example, the operation unit 808 receives instruction operations such as an adjustment of the size of the projection image, an adjustment of a color tone, a focus adjustment, and a keystone adjustment, and outputs the received operation to the CPU 801.

The power switch 809 is a switch to switch ON/OFF of the power of the image projection apparatus 1.

The bus 810 is an address bus and a data bus for electrically connecting the components such as the CPU 801 illustrated in FIG. 6.

The network I/F 811 is an interface circuit to perform data communication using a communication network such as the Internet.

The phosphor wheel drive circuit 812 is a drive circuit for controlling the rotation of the phosphor wheel PW (i.e., phosphor wheels PWa and PWb) via a motor.

The a color wheel drive circuit 813 is a drive circuit for controlling the rotation of the color wheel CW via a motor.

The light source drive circuit 814 is a driving circuit that controls the turning on and off of the light sources LD (i.e., light sources LDa and LDb) under the control of the CPU 801.

The digital micromirror device DMD is a device for converting light source light (i.e., light source light emitted from the illumination optical system 11) originated from the light source LD into image light by a spatial light modulation method using a large number of movable micromirrors based on image data input from the external device connection I/F 818, and projecting the image light onto a projection surface such as a screen through the projection lens 12. A liquid crystal panel may be used instead of the digital micromirror device DMD.

The external device connection I/F 818 is an interface circuit to which an information processing apparatus such as a personal computer (PC) is connected and that transmits and receives control signals and image data to and from the information processing apparatus.

The fan drive circuit 819 is a drive circuit that is connected to the CPU 801 and the cooling fan 820, and drives or stops the cooling fan 820 based on a control signal from the CPU 801.

The cooling fan 820 rotates to exhaust the air inside the image projection apparatus 1 to cool the inside of the image projection apparatus 1.

When the power is supplied, the CPU 801 executes a control program stored in the ROM 802 in advance, and sends a control signal to the light source drive circuit 814 to turn on the light source LD, and sends a control signal to the fan drive circuit 819 to rotate the cooling fan 820 at a predetermined rotation speed. In the image projection apparatus 1, when the power supply circuit starts the power supply, the digital micromirror device DMD is in a state that the digital micromirror device DMD can display an image, and further, the power supply circuit supplies the electric power to other various components. In the image projection apparatus 1, when the power switch 809 is turned off, a power-off signal is sent from the power switch 809 to the CPU 801, and when the CPU 801 detects the power-off signal, the CPU 801 sends a control signal to the light source drive circuit 814 to turn off the light source LD. After a predetermined time has passed, the CPU 801 sends a control signal to the fan drive circuit 819 to stop the cooling fan 820, terminates the control process, and sends an instruction to the power supply circuit to stop the power supply.

### Rotating Operation of Phosphor Wheel and Color Wheel

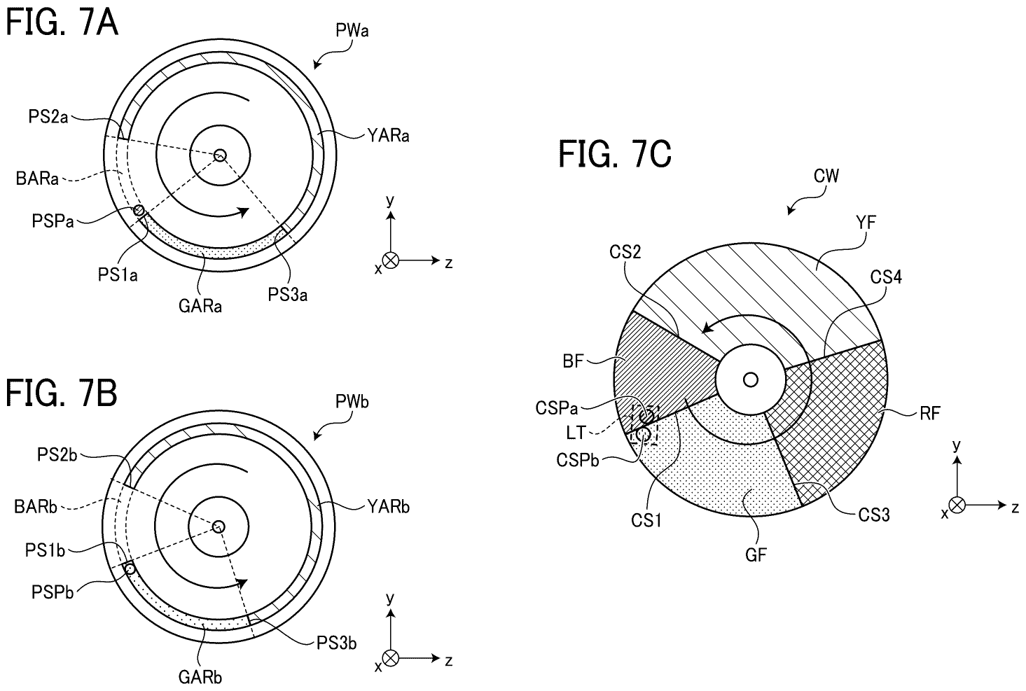

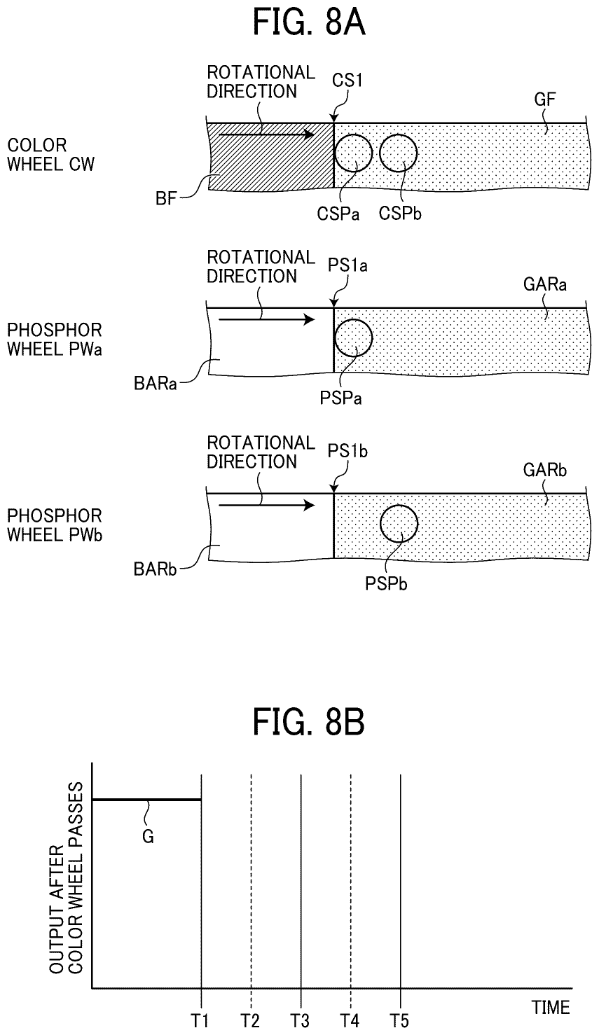

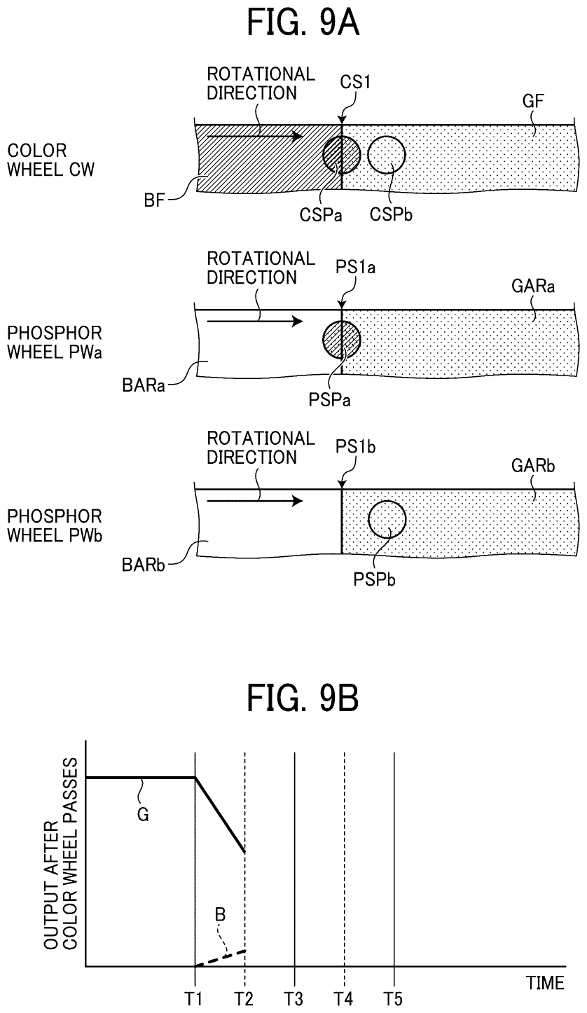

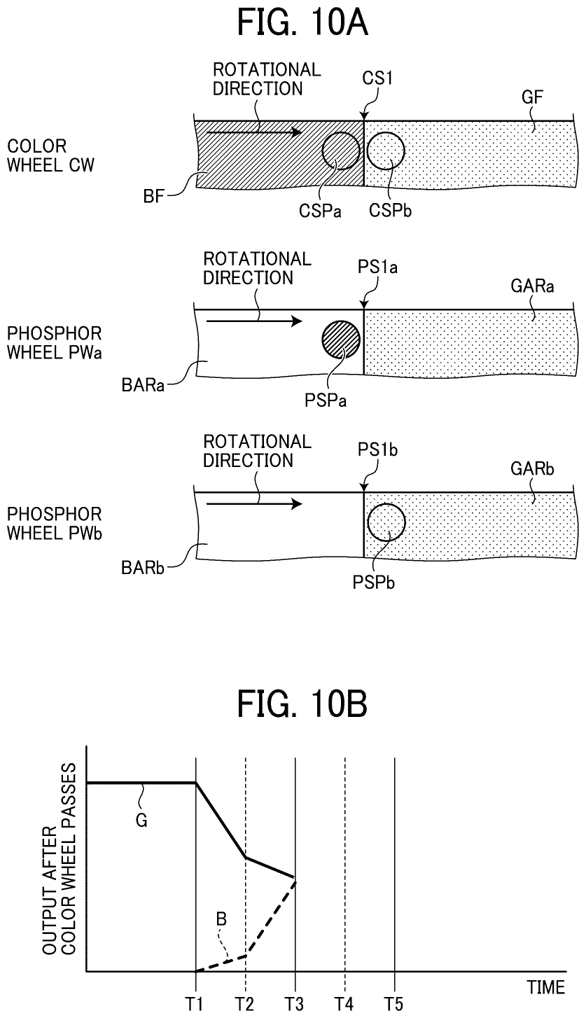

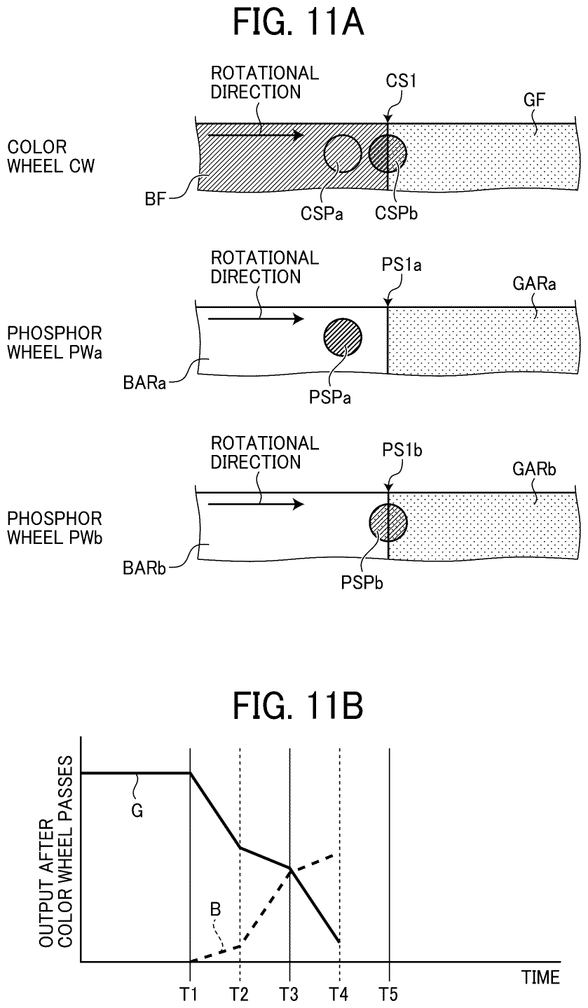

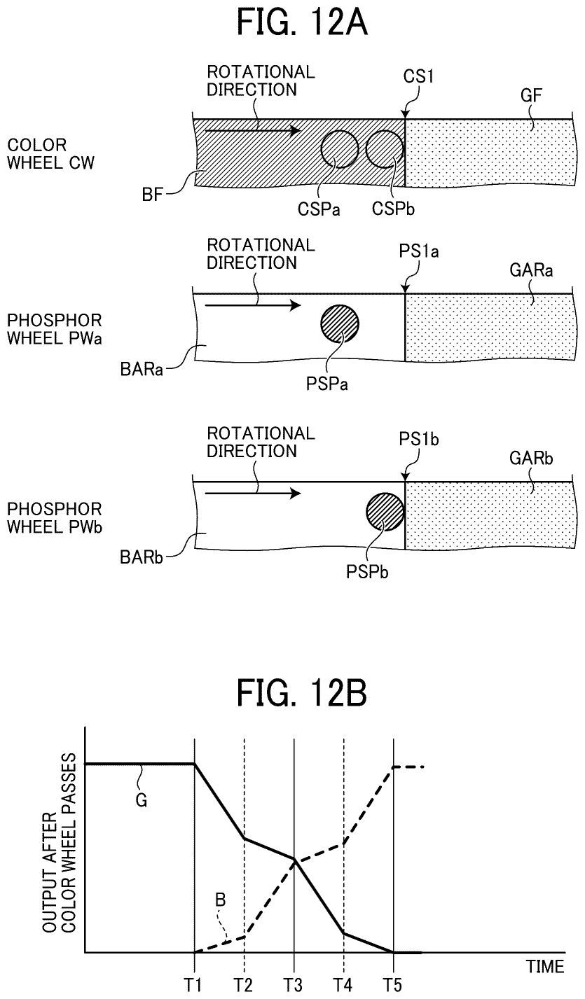

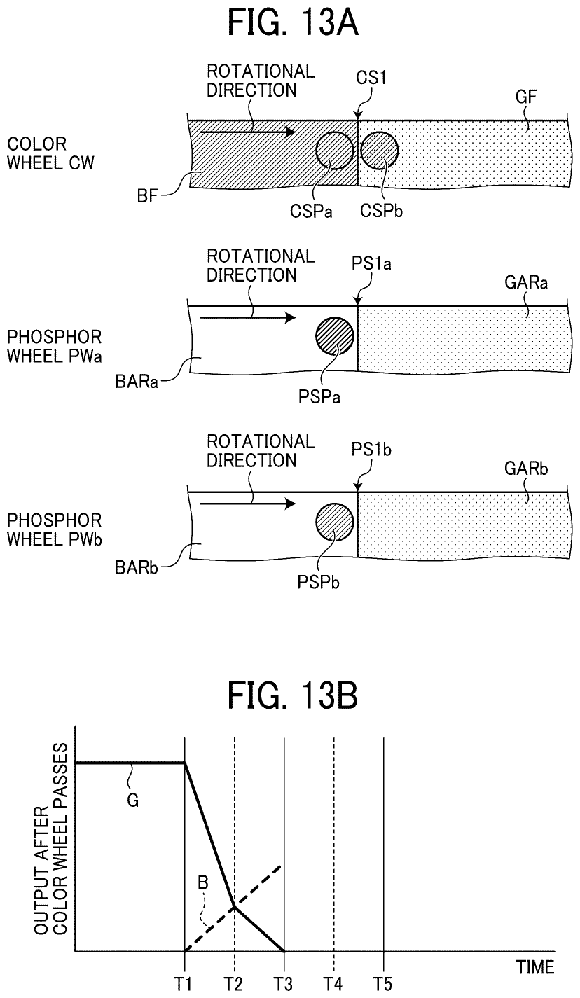

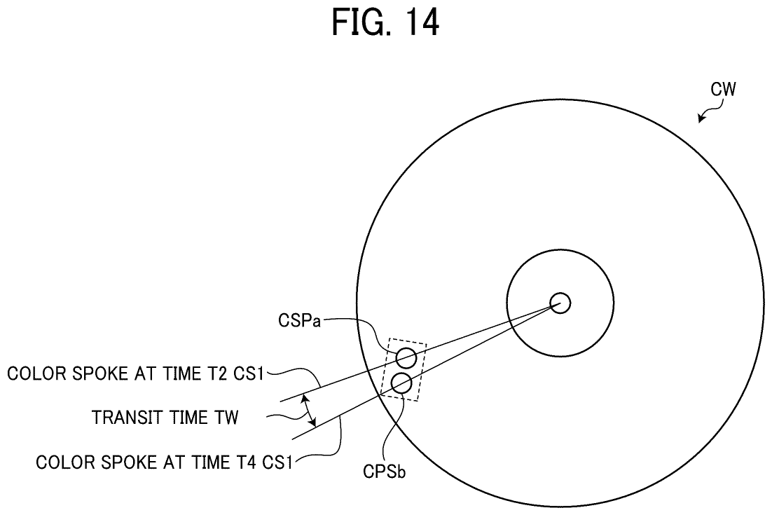

FIGS. 7A and 7B are diagrams illustrating the timing of a spoke time of a phosphor wheel in the light source device. FIG. 7C is a diagram illustrating the timing of a spoke time of a color wheel in the light source device. FIG. 8A is a diagram illustrating positional relations between a spoke of a phosphor wheel, another spoke of another phosphor wheel, and a spot of light source light in a light source device at a time T1. FIG. 8B is a graph of output of the light source light passed through the color wheel at the time T1. FIG. 9A is a diagram illustrating positional relations between a spoke of a phosphor wheel, another spoke of another phosphor wheel, and a spot of light source light in a light source device at a time T2. FIG. 9B is a graph of output of the light source light passed through the color wheel at the time T2. FIG. 10A is a diagram illustrating positional relations between a spoke of a phosphor wheel, another spoke of another phosphor wheel, and a spot of light source light in a light source device at a time T3. FIG. 10B is a graph of output of the light source light passed through the color wheel at the time T3. FIG. 11A is a diagram illustrating positional relations between a spoke of a phosphor wheel, another spoke of another phosphor wheel, and a spot of light source light in a light source device at a time T4. FIG. 11B is a graph of output of the light source light passed through the color wheel at the time T4. FIG. 12A is a diagram illustrating positional relations between a spoke of a phosphor wheel, another spoke of another phosphor wheel, and a spot of light source light in a light source device at a time T5. FIG. 12B is a graph of output of the light source light passed through the color wheel at the time T5. FIG. 13A is a diagram illustrating positional relations between a spoke of a phosphor wheel, another spoke of another phosphor wheel, and a spot of light source light in a light source device in a case where a timing when the spoke passes through the spot and another timing when the other spoke passes through the spot are matched. FIG. 13B is a graph of output of the light source light passed through the color wheel in a case where a timing when the spoke passes through the spot and another timing when the other spoke passes through the spot are matched. FIG. 14 is a diagram illustrating a transit time that a spoke of a color wheel passes through two spots in in the light source device. Referring to FIGS. 7 to 14, the timing at which the phosphor spoke of the phosphor wheel PW passes through the phosphor-side spot and the timing at which the color spoke of the color wheel CW passes through the color-side spot in the light source device 10 will be described.

FIGS. 7A, 7B, and 7C are diagrams illustrating a positional relation between the positions of phosphor-side spots on a phosphor wheel PWa, the positions of a phosphor-side spot on a phosphor wheel PWb, and the position of a color-side spot on a color wheel PW at a specific timing, respectively, in the light source device 10. Specifically, as illustrated in FIG. 7A, the light source light is reflected by a reflection area BARa of the phosphor wheel PWa so that a phosphor-side spot PSPa (i.e., first phosphor-side spot) is formed, and as illustrated in FIG. 7C, the light source light goes in a filter area BF of the color wheel CW so that a color-side spot CSPa (i.e., first color-side spot) is formed. Further, as illustrated in FIG. 7B, the light source light is reflected by a reflection area GARa of the phosphor wheel PWb so that a phosphor-side spot PSPb (i.e., second phosphor-side spot) is formed, and as illustrated in FIG. 7C, the light source light goes in a filter area GF of the color wheel CW so that a color-side spot CSPb (i.e., second color-side spot) is formed. As described above, in the present embodiment, the color spoke sequentially passes through the multiple color-side spots formed on the color wheel CW. As viewed from the positive direction of the x-axis in FIG. 4, the color wheel CW and the phosphor wheel PWa rotate counterclockwise around the center of the disc as a rotation axis, for example, as illustrated in FIGS. 7A, 7B, and 7C. The phosphor wheel PWb rotates around the center of the disc as a rotation axis so as to have the same correspondence in the rotation direction between the color wheel CW and the phosphor wheel PWa. As illustrated in FIG. 7A, in the phosphor wheel PWa, the boundary between the reflection region BARa and the wavelength conversion region GARa is defined as a phosphor spoke PS1a, the boundary between the wavelength conversion region YARa and the reflection region BARa is defined as a phosphor spoke PS2a, and the boundary between the wavelength conversion region GARa and the wavelength conversion region YARa is defined as a phosphor spoke PS3a. As illustrated in FIG. 7B, in the phosphor wheel PWb, the boundary between the reflective region BARb and the wavelength-conversion region GARb is defined as a phosphor spoke PS1b, the boundary between the wavelength-conversion region YARb and the reflective region BARb is defined as a phosphor spoke PS2b, and the boundary between the wavelength-conversion region GARb and the wavelength-converting region YARb is defined as a phosphor spoke PS3b. As illustrated in FIG. 7C, in the color wheel CW, the boundary between the filter region BF and the filter region GF is defined as a color spoke CS1, the boundary between the filter region YF and the filter region BF is defined as a color spoke CS2, the boundary between the filter region GF and the filter region RF is defined as a color spoke CS3, and the boundary between the filter region RF and the filter region YF is defined as a color spoke CS4. In the following description, the phosphor spoke PS1a of the phosphor wheel PWa, the phosphor spoke PS1b of the phosphor wheel PWb, and the color spoke CS1 of the color wheel CW will be described with attention. In this case, the phosphor spoke PS1a correspond to the “first phosphor spoke”, and the phosphor spoke PS1b correspond to the “second phosphor spoke”.

As illustrated in FIG. 8A, in the color wheel CW, the time when the color spoke CS1 starts to pass through the color-side spot CSPa is defined as a time T1. At the time T1, the phosphor spoke PS1a also starts to pass through the phosphor-side spot PSPa in the phosphor wheel PWa. At time T1, the light source light, the wavelength of which has been converted into green fluorescent light at the phosphor-side spot PSPa in the wavelength-conversion region GARa of the phosphor wheel PWa, passes through the color-side spot CSPa in the filter region GF of the color wheel CW. Similarly, the light source light, the wavelength of which has been converted into the green fluorescent light by the phosphor-side spot PSPb of the wavelength conversion region GARb of the phosphor wheel PWb, passes through the color-side spot CSPb of the filter region GF of the color wheel CW. FIG. 8B is a graph of the output of the light source light passing through the color wheel CW, which is the output of the green light source light passing through the color-side spots CSPa and CSPb.

As illustrated in FIG. 9A, in the color wheel CW, the time when the color spoke CS1 passes near the center of the color-side spot CSPa is defined as a time T2. At the time T2, the phosphor spoke PS1a also passes near the center of the phosphor-side spot PSPa in the phosphor wheel PWa. At the time T2, the light source light, the wavelength of which has been converted into green fluorescent light by the phosphor-side spot PSPb in the wavelength-conversion region GARb of the phosphor wheel PWb, passes through the color-side spot CSPb in the filter region GF of the color wheel CW. On the other hand, since the phosphor-side spot PSPa is formed at the phosphor spoke PS1a of the phosphor wheel PWa, color mixing occurs, and further, the light source light of color mixing passes through the color spoke CS1 of the color wheel CW. Thus, as illustrated in FIG. 9B, since the output of the green light source passing through the color wheel CW is decreased and the blue light source is included in the light source light of the mixing color, the output of the blue light source light is increased.

As illustrating in FIG. 10A, in the color wheel CW, the time when the color spoke CS1 passes between the color-side spot CSPa and the color-side spot CSPb is defined as a time T3. At the time T3, the phosphor spoke PS1a finishes passing the phosphor-side spot PSPa in the phosphor wheel PWa. At the time T3, the phosphor spoke PS1b starts to pass the phosphor-side spot PSPb in the phosphor wheel PWb. At the time T3, the blue light source light reflected by the phosphor-side spot PSPa of the phosphor wheel PWa passes through the color-side spot CSPa of the filter region BF of the color wheel CW. The light source light, the wavelength of which has been converted into the green fluorescent light by the phosphor-side spot PSPb in the wavelength conversion region GARb of the phosphor wheel PWb, passes through the color-side spot CSPb in the filter region GF of the color wheel CW. Thus, as illustrated in FIG. 10B, the blue light source light and the green light source light passing through the color wheel CW have substantially the same output.

As illustrated in FIG. 11A, in the color wheel CW, the time when the color spoke CS1 passes near the center of the color-side spot CSPb is defined as a time T4. At the time T4, the phosphor spoke PS1b also passes near the center of the phosphor-side spot PSPb in the phosphor wheel PWb. At the time T4, the blue light source light reflected by the phosphor-side spot PSPa in the reflection region BARa of the phosphor wheel PWa passes through the color-side spot CSPb in the filter region BF of the color wheel CW. On the other hand, since the phosphor-side spot PSPb is formed at the phosphor spoke PS1b of the phosphor wheel PWb, color mixing occurs, and further, the light source light of color mixing passes through the color spoke CS1 of the color wheel CW. Thus, as illustrated in FIG. 11B, since the output of the green light source passing through the color wheel CW is decreased and the blue light source light is included in the light source light of mixing color, the output of the blue light source is increased.

As illustrated in FIG. 12A, in the color wheel CW, the time when the color spoke CS1 has passed through the color-side spot CSPb is defined as a time T5. At the time T5, the phosphor spoke PS1b also finishes passing through the phosphor-side spot PSPb in the phosphor wheel PWb. At the time T5, the blue light source light reflected by the phosphor-side spot PSPa in the reflection region BARa of the phosphor wheel PWa passes through the color-side spot CSPa in the filter region BF of the color wheel CW. Similarly, the blue light source light reflected by the phosphor-side spot PSPb in the reflection region BARb of the phosphor wheel PWb passes through the color-side spot CSPb in the filter region BF of the color wheel CW. Thus, as illustrated in FIG. 12B, the graph is the output of the blue light source light that has passed through the color-side spots CSPa and CSPb.

For example, in the case where the color spoke CS1 of the color wheel CW passes through the color-side spot CSPa at such a timing that not only the phosphor spoke PS1a of the phosphor wheel PWa passes through the phosphor-side spot PSPa but also the phosphor spoke PS1b of the phosphor wheel PWb passes through the phosphor-side spot PSPb, the light use efficiency at the spoke time is decreased. For example, in the case of such a rotation timing, the state at a time corresponding to the time T3 at which the color spoke CS1 passes through a space between the color-side spot CSPa and the color-side spot CSPb in the color wheel CW illustrated in FIG. 10 is illustrated in FIGS. 13A and 13B. As illustrated in FIG. 13A, at the time, the blue light source light reflected by the phosphor-side spot PSPa of the phosphor wheel PWa passes through the color-side spot CSPa of the filter region BF of the color wheel CW. However, since the blue light source reflected by the phosphor-side spot PSPb of the phosphor wheel PWb goes in the color-side spot CSPb of the filter region GF of the color wheel CW, the light use efficiency is much decreased. As a result, as illustrated in FIG. 13B, although the blue light source light passing through the color-side spot CSPa of the filter region BF passes through the color wheel CW, the blue light source light going in the color-side spot CSPb of the filter region GF hardly passes through the color wheel CW, so that the output of the green light source light passing through the color wheel CW becomes substantially zero, and the light use efficiency is much decreased.

In contrast, in the light source device 10, as described with reference to FIGS. 8A to 12B, when the color spoke CS1 of the color wheel CW passes through the color-side spot CSPa, the phosphor spoke PS1a of the phosphor wheel PWa passes through the phosphor-side spot PSPa, and when the color spoke CS1 of the color wheel CW passes through the color-side spot CSPb, the phosphor spoke PS1b of the phosphor wheel PWb passes through the phosphor-side spot PSPb. As a result, the light use efficiency in the spoke time can be increased.

The color spoke CS1 passes through the color-side spot CSPa within the time period during which the phosphor spoke PS1a passes through the phosphor-side spot PSPa. The color spoke CS1 passes through the color-side spot CSPb within the time period during which the phosphor spoke PS1b passes through the phosphor-side spot PSPb. As a result, the loss of light within the spoke time can be minimized, and the light source device 10 having a higher efficiency as a whole can be provided.

In the color wheel CW, the color-side spot CSPa formed by the light source light originated from the light source module Mda and the color-side spot CSPb formed by the light source light originated from the light source module Mdb are formed with the centers thereof spaced from each other in the scanning direction of the color spoke CS1, as illustrated in FIG. 14. In other words, the center of the color-side spot CSPa is shifted from the center of the color-side spot CSPb. In this case, the color wheel CW is disposed such that the color spoke CS1 passes through the color-side spot CSPa and the color-side spot CSPb in order. Thus, there is a time difference between the timing when the color spoke CS1 passes near the center of the color-side spot CSPa and the timing when the color spoke CS1 passes near the center of the color-side spot CSPb. This time difference is defined as a transit time Tw. Another time difference between the timing when the phosphor spoke PS1a of the phosphor wheel PWa passes through the phosphor-side spot PSPa and the timing when the phosphor spoke PS1b of the phosphor wheel Pwb passes through the phosphor-side spot PSPb is adjusted to match the transit time Tw so that the light use efficiency in the spoke time can be increased.

In order to adjust the rotation timing of the color wheel CW and the phosphor wheels PWa and PWb, for example, the adjustment is performed as follows. When the color spoke CS1 of the color wheel CW passes through the color-side spot CSPa, the adjustment is performed such that the phosphor spoke PS1a of the phosphor wheel PWa passes through the phosphor-side spot PSPa. When the color spoke CS1 of the color wheel CW passes through the color-side spot CSPb, the adjustment is performed such that the phosphor spoke PS1b of the phosphor wheel PWb passes through the phosphor-side spot PSPb. The adjustment of the phosphor wheel PWa and the adjustment of the phosphor wheel PWb may be reversed. Alternatively, the following adjustment may be performed. When the color spoke CS1 of the color wheel CW passes through the color-side spot CSPa, the adjustment is performed such that the phosphor spoke PS1a of the phosphor wheel PWa passes through the phosphor-side spot PSPa. Assuming that the transit time Tw, which is a time difference between the timing when the color spoke CS1 passes near the center of the color-side spot CSPa and the timing when the color spoke CS1 passes near the center of the color-side spot CSPb, is known, the adjustment is performed such that the time difference between the timing when the phosphor spoke PS1a of the phosphor wheel PWa passes near the phosphor-side spot PSPa and the timing when the phosphor spoke PS1b of the phosphor wheel PWb passes near the phosphor-side spot PSPb matches the transit time Tw. The adjustment of the phosphor wheel PWa and the adjustment of the phosphor wheel PWb may be reversed. With such an adjustment method, the light source device 10 that can increase the light use efficiency in the spoke time can be provided. Although the timing is described as time in the above description, the reference of the adjustment may be defined by an angle with 360 degrees as one cycle because the time depends on the distance from the rotation center of each spot or the rotation speed of each wheel and may be complicated to handle.

In FIGS. 7A to 14, the color spoke CS1 passes through the color-side spot CSPa and the color-side spot CSPb in this order, but the color spoke CS1 may pass through the color-side spot CSPb and the color-side spot CSPa in this order. In FIGS. 7A to 14, the phosphor spokes PS1a of the phosphor wheel PWa, the phosphor spokes PS1b of the phosphor wheel PWb, and the color spokes CS1 of the color wheel CW will be described with attention. However, the spokes are not limited to these spokes. Other spokes of the phosphor wheels PWa and PWb and the color wheel CW are the same.

As described above, the light source device 10 includes the light source module Mda, the light source module Mdb, and the color wheel CW. The light source module Mda includes the light source LDa to emit light source light and the phosphor wheel PWa including multiple regions that emit light source light having multiple wavelengths each different from a wavelength of the light source light emitted from the light source LDa, having a shape of disc, and rotating around the rotation axis at the center of the disc. The light source module Mdb includes the light source LDb to emit light source light and the phosphor wheel PWb including multiple regions that emit light source light having multiple wavelengths each different from a wavelength of the light source light emitted from the light source LDb, having a shape of disc, and rotating around the rotation axis at the center of the disc. The color wheel CW includes multiple filter regions having transmittances different from each other, has a shape of disc, and rotates around the rotation axis at the center of the disc. The phosphor wheel PWa is irradiated with the light source light from the light source LDa to form a phosphor-side spot PSPa. The phosphor wheel PWb is irradiated with the light source light from the light source LDb to form a phosphor-side spot PSPb. In the color wheel CW, the light source light generated at the light source module Mda forms a color-side spot CSPa and the light source light generated at the light source module Mdb forms a color-side spot CSPb. The light source module Mda, the light source module Mdb, and the color wheel CW are disposed such that the color spoke CS1, which is a boundary between the multiple filter regions, passes through the color-side spot CSPa and the color-side spot CSPb in this order or the color-side spot CSPb and the color-side spot CSPa in this order. As a result, the light use efficiency in the spoke time can be increased. Since the light source module Mda, the light source module Mdb, and the color wheel CW can be disposed such that the color spoke passes from the color-side spot CSPa to the color-side spot CSPb in this order or from the color-side spot CSPb to the color-side spot CSPa in this order, the center of rotation of the color wheel can be disposed at any position while the high light use efficiency is maintaining. As a result, the image projection apparatus 1 can be reduced in size. In addition, the light source device 10 can have any layout, and the image projection device 1 can be reduced in size while maintaining high light use efficiency. The light source LDa included in the light source module Mda and the light source LDb included in the light source module Mdb are described as separated light sources. However, the light source light may be multi-divided by a half mirror or a polarization beam splitter that transmits a portion of the light source light emitted from a single light source and reflects another portion of the light source light, and the light source light may be guided to the phosphor wheels PWa and PWb of the multiple light source modules Mda and Mdb, respectively.

In the above-described embodiments, when at least one of the functional units of the image projection apparatus 1 is implemented by executing a program, the program is installed in advance in, for example, a ROM. In the above-described embodiments, the programs executed by the image projection apparatus 1 may be recorded in and provided with a computer-readable recording medium such as a compact disc read-only memory (CD-ROM), a flexible disk (FD), a compact disc-recordable (CD-R), or a digital versatile disc (DVD) in a file in an installable or executable format. In the above-described embodiments, the programs executed by the image projection apparatus 1 may be stored in a computer connected to a network such as the Internet, and may be provided by downloading the program via the network. In the above-described embodiments, the programs executed by the image projection apparatuses 1 may be provided or distributed via a network such as the Internet. In the above-described embodiments, the program executed by the image projection apparatus 1 includes a module configuration including at least one of the functional units, and as an actual hardware, the CPU 801 reads out the program from the storage device (e.g., ROM 802) and executes the program so that the functional units are loaded onto the main storage device (e.g., RAM 803) and generated.

Aspects of the present disclosure are as follows.

### First Aspect

A light source device includes a first light source module including a first light source, a first phosphor wheel including multiple regions to emit light source light having a wavelength different from the light source light emitted from the first light source, or a region to emit light source light emitted from the first light source and multiple regions to emit light source light having a wavelength different from the light source light, having a shape of a disc, and rotating around the center of the disc as a rotation axis, a second light source module including a second light source, a second phosphor wheel including multiple regions to emit light source light having a wavelength different from the light source light emitted from the second light source, or a region to emit light source light emitted from the first second source and multiple regions to emit light source light having a wavelength different from the light source light, having a shape of a disc, and rotating around the center of the disc as a rotation axis, and a color wheel including multiple filter regions having different transmittances different from each other, having a shape of a disc, and rotating around the center of the disc as a rotation axis. The light source light emitted from the first light source forms a first phosphor-side spot on the first phosphor wheel. The light source light emitted from the second light source forms a second phosphor-side spot on the second phosphor wheel. The light source light generated from the first light source module forms a first color-side spot on the color wheel and the light source light generated from the second light source module forms a second color-side spot on the color wheel. A color spoke that is a boundary between the multiple filter regions passes through the first color-side spot and the second color-side spot or the second color-side spot and the first color-side spot in this order.

### Second Aspect

In the light source device according to the first aspect, the center of the first color-side spot is shifted from the center of the second color-side spot.

### Third Aspect

In the light source device according to the first or second aspect, when the color spoke passes through the first color-side spot, a first phosphor spoke that is a boundary among the multiple regions of the first phosphor wheel passes through the first phosphor-side spot, and when the color spoke passes through the second color-side spot, a second phosphor spoke that is a boundary among the multiple regions of the second phosphor wheel passes through the second phosphor-side spot.

### Fourth Aspect

In the light source device according to the third aspect, a time difference between a time when the color spoke passes through the center of the first color-side spot and a time when the color spoke passes through the center of the second color-side spot is matched with a time difference between a time when the first phosphor spoke passes through the first phosphor-side spot and a time when the second phosphor spoke passes through the second phosphor-side spot.

### Fifth Aspect

In the light source device according to the third aspect, the color spoke passes through the first color-side spot within a time when the first phosphor spoke passes through the phosphor-side spot.

### Sixth Aspect

In the light source device according to the third aspect, the color spoke passes through the second color-side spot within a time when the second phosphor spoke passes through the phosphor-side spot.

### Seventh Aspect

In the light source device according to any one of the first to sixth aspects, the first light source and the second light source emit blue light as the light source light, and the multiple regions include a wavelength conversion region to convert a wavelength of the blue light into another wavelength longer than the wavelength of the blue light.

### Eighth Aspect

An image projection apparatus includes the light source device according to any one of the first to seventh aspects and a light tunnel having an entrance surface with a shape of a rectangle having a longitudinal side and a lateral side, to uniformize the light source light passed through the color wheel and gone in from the entrance surface. The light source light from the first light source module goes in the entrance surface to form a light condensed spot and the light source light from the second light source module goes in the entrance surface to form a light condensed spot. An alignment direction of the two spots matches the direction of the longitudinal side of the entrance surface.

### Ninth Aspect

The image projection apparatus according to the eight aspect further includes a two-dimensional light modulator to convert the light source light passed through the light tunnel into an image light including an image and a projection optical system to project the image light converted by the two-dimensional light modulator.

### Tenth Aspect

A method for adjusting the light source device according to any one of the third to sixth aspects includes adjusting the first phosphor spoke of the first phosphor wheel so as to pass through the first phosphor-side spot when the color spoke of the color wheel passes through the first color-side spot and adjusting the second phosphor spoke of the second phosphor wheel so as to pass through the first phosphor-side spot when the color spoke of the color wheel passes through the second color-side spot.

### Eleventh Aspect

A method for adjusting the light source device according to any one of the third to sixth aspects includes adjusting the first phosphor spoke of the first phosphor wheel so as to pass through the first phosphor-side spot when the color spoke of the color wheel passes through the first color-side spot and matching a time difference between a time when the first phosphor spoke of the first phosphor wheel passes through the first phosphor-side spot and a time when the second phosphor spoke of the second phosphor wheel passes through the second phosphor-side spot with a time difference between a time when the color spoke passes through the center of the first color-side spot and a time when the color spoke passes through the center of the second color-side spot.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A light source device comprising:
a first light source module including:
a first light source to emit a first light-source light having a first wavelength;
a first phosphor wheel including a first disc rotating about a central axis of the first disc,
the first phosphor wheel including multiple regions having:
a first region to reflect the first light-source light emitted from the first light source; and
a second region to generate a second light-source light having a second wavelength different from the first wavelength of the first light-source light from the first light-source light, to form a first phosphor-side spot on the first phosphor wheel by the first light-source light or the second light-source light;
a second light source module including:
a second light source to emit a third light-source light having a third wavelength;
a second phosphor wheel including a second disc rotating about a central axis of the second disc, the second phosphor wheel including multiple filter regions having:
a third region to reflect the third light-source light emitted from the second light source; and
a fourth region to generate a fourth light-source light having a fourth wavelength different from the third wavelength of the second light-source light from the third light-source light, to form a second phosphor-side spot on the second phosphor wheel by the third light-source light or the fourth light-source light;
a color wheel having a third disc rotating about a central axis of the third disc, the color wheel including: multiple filter regions having transmittances different from each other; and a color spoke between the multiple filter regions; and
circuitry configured to:
control the first light source module to form a first color-side spot on the color wheel by one of the first light-source light or the second light-source light,
control the second light source module to form a second color-side spot on the color wheel by one of the third light-source light or the fourth light-source light, and
control the color wheel to cause the color spoke to passe through from the first color-side spot to the second color-side spot or from the second color-side spot to the first color-side spot.

2. The light source device according to claim 1,
wherein the circuitry is further configured to:
control the first light source module to form the first color-side spot on the color wheel; and
control the second light source module to form the second color-side spot on the color wheel, and
a center of the first color-side spot is shifted from a center of the second color-side spot in a radial direction of the color spoke.

3. The light source device according to claim 1,
wherein the first phosphor wheel have a first phosphor spoke at a boundary between the first region and the second region,
the second phosphor wheel have a second phosphor spoke at a boundary between the third region and the fourth region, and
the circuitry is further configured to control the color wheel to cause:
the first phosphor spoke to pass through the first phosphor-side spot when the color spoke passes through first color-side spot, and
the second phosphor spoke to pass through the second phosphor-side spot when the color spoke passes through first color-side spot.

4. The light source device according to claim 3,
wherein the circuitry is further configured to control the first phosphor wheel, the second phosphor wheel, and the color wheel to generate:
a first time difference between:
a time when the color spoke passes through a central axis of the first color-side spot; and
a time when the color spoke passes through a central axis of the second color-side spot; and
a second time difference between:
a time when the first phosphor spoke passes through the first phosphor-side spot; and
a time when the second phosphor spoke passes through the second phosphor-side spot, and
cause the first time difference to be matched with the second time difference.

5. The light source device according to claim 3,
wherein the circuitry is further configured to control the color wheel to cause the color spoke to pass through the first color spot within a time when the first phosphor spoke passes through the first phosphor-side spot.

6. The light source device according to claim 3,
wherein the color spoke passes through the second color spot within a time when the second phosphor spoke passes through the second phosphor-side spot.

7. The light source device according to claim 1,
wherein the first light source and the second light source emit blue light having a first wavelength, and the multiple regions include wavelength conversion regions that convert the first wavelength into a second wavelength longer than the first wavelength.

8. An image projection apparatus comprising:
the light source device according to claim 1; and
a light tunnel having an entrance surface having a rectangular shape having a longitudinal side and a lateral side, to uniformize light source light passed through the color wheel,
wherein the first light source module and the second light source module form light-condensed spots at the entrance surface of the light tunnel, the light-condensed spots aligned in a direction of the longitudinal side of the entrance surface.

9. The image projection apparatus according to claim 8, further comprising:
a two-dimensional light modulator to convert the light source light into image light including an image; and a projection optical system to project the image light converted by the two-dimensional light modulator.

10. A method for adjusting a light source device comprising:
adjusting a timing of a first phosphor wheel to pass a first phosphor spoke of the first phosphor wheel through a first phosphor-side spot of the first phosphor wheel when a color spoke of a color wheel passes through a first color-side spot of the color wheel; and
adjusting a timing of a second phosphor wheel to pass a second phosphor spoke of the second phosphor wheel through the first phosphor-side spot when the color spoke of the color wheel passes through a second color-side spot of the color wheel.

11. The method for adjusting the light source device according to claim 10, further comprising:
matching a time different between a time when the first phosphor spoke of the first phosphor wheel passes the first phosphor-side spot and a time when the second phosphor spoke of the second phosphor wheel passes a second phosphor-side spot with a time difference between a time when the color spoke of the color wheel passes through a central axis of the first color-side spot of the color wheel and a time when the color spoke of the color wheel passes through a central axis of the second color-side spot of the color wheel.

12. A light source device comprising:
a first light source module including:
a first light source to emit a first light-source light having a first wavelength;
a first phosphor wheel including a first disc rotating about a central axis of the first disc,
the first phosphor wheel including multiple regions having
a first region to generate a second light-source light having a second wavelength different from the first wavelength of the first light-source light from the first light-source light, to form a first phosphor-side spot on the first phosphor wheel by the second light-source light;
a second light source module including:
a second light source to emit a third light-source light having a third wavelength;
a second phosphor wheel including a second disc rotating about a central axis of the second disc, the second phosphor wheel including multiple regions having
a second region to generate a fourth light-source light having a fourth wavelength different from the third wavelength of the second light-source light from the third light-source light, to form a second phosphor-side spot on the second phosphor wheel by the fourth light-source light;
a color wheel having a third disc rotating about a central axis of the third disc, the color wheel including: multiple filter regions having transmittances different from each other;
and a color spoke between the multiple filter regions; and
circuitry configured to:
control the first light source module to form a first color-side spot on the color wheel by one of the first light-source light or the second light-source light,
control the second light source module to form a second color-side spot on the color wheel by one of the third light-source light or the fourth light-source light,
control the color wheel to cause the color spoke to passe through: from the first color-side spot to the second color-side spot; or from the second color-side spot to the first color-side spot.
